(19) United States
(12) Patent Application Publication
(10) Pub. No.: US 2001/0042458 A1
(43) Pub. Date: Nov. 22, 2001

(54) Printing stencil for a screen-printing machine and method for its production

(76) Inventor: Mircea Iliescu, Ellwangen (DE)

Correspondence Address: OSTROLENK FABER GERB & SOFFEN, 1180 AVENUE OF THE AMERICAS, NEW YORK, NY, 100368403

(21) Appl. No.: 09/799,139

(22) Filed: Jun. 12, 2001

(30) Foreign Application Priority Data
Mar. 7, 2000 (DE) 100 11 058.4

(51) Int. Cl. B41L 13/00; B05C 17/06

(52) U.S. Cl. 101/127.1

(57) ABSTRACT

A printing stencil for a screen-printing machine is proposed, having a frame (1) which holds a screen element and being distinguished by the fact that the screen element is substantially curved in a U shape, and by the fact that its concave side is assigned to a pressure squeegee and its convex side is assigned to the surface to be printed.

The invention relates to a printing stencil for a screen-printing machine, having a frame holding a screen element, according to the preamble of claim 1, and to a method according to claim 9.

Screen-printing machines are known. Amongst other things, they can also be used for printing curved surfaces, such as those provided in the case of cans, bottles or the like. In particular when screen-printing machines are used on rotary index table machines, which are used to print cans, bottles or the like, the space required by the printing stencils is disadvantageous.

It is therefore an object of the invention to provide a printing stencil for a screen-printing machine and a method for its production which do not exhibit these disadvantages.

In order to achieve this object, a printing stencil is proposed which has the features cited in claim 1. It is distinguished by the fact that it has a screen element which is held by a frame and which is substantially curved in a U shape. Its concave side faces a pressure squeegee and its convex side faces the surface to be printed. The pressure squeegee therefore acts in the interior of the U-shaped screen element, so that conventional screen printing can be carried out.

One exemplary embodiment of the printing stencil is preferred because the frame has at least two substantially U-shaped frame elements which are arranged at a distance from each other and whose spacing is variable.

Also preferred is an exemplary embodiment of the printing stencil whose screen element is cylindrical or conical. It is therefore possible to print not only cylindrical but also conical articles with the aid of the printing screen formed in this way.

Finally, an exemplary embodiment of the printing stencil is preferred which is distinguished by a drive device which specifically drives the printing stencil. It is specifically subjected to a pivoting movement, so that the printing operation can be carried out in the case of a rotating curved article, for example a can or a bottle, while the printing stencil does not need to execute any translational movement. As a result of the pivoting movement of the printing stencil, the print is applied to the rotating article.

In order to achieve the named object, a method is also proposed which comprises the steps cited in claim 7. During the production of the printing stencil, a molding is introduced into a frame which has a substantially U-shaped curved outer surface. The frame is distinguished by substantially U-shaped frame elements arranged at a distance from each another. On the molding and on the frame elements, on the convex side, a screen fabric is fitted and tensioned, the tensioning forces acting on the screen fabric running transversely with respect to the longitudinal extent of the molding but also longitudinally in relation thereto. The screen fabric is then fixed on the convex side of the frame elements and the latter are displaced in relation to each other in such a way that their spacing is increased. The screen fabric is therefore tensioned in the longitudinal direction of the molding and of the frame. Finally, the screen fabric is fixed to the longitudinal elements of the frame which connect the U-shaped frame elements. The molding can be removed just after the screen fabric is fixed to the convex side of the frame elements. However, it can also be removed from the interior of the frame after the screen fabric has been fixed completely to said frame.

The invention will be explained in more detail below using the drawing, in which:

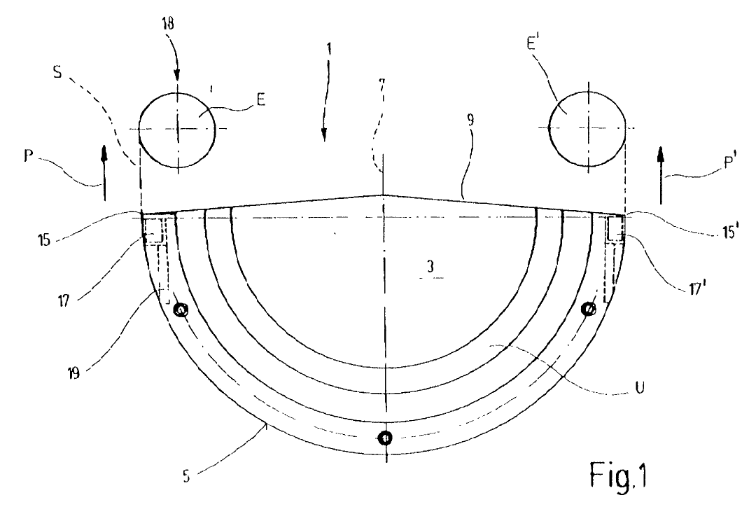

FIG. 1 shows a first exemplary embodiment of a frame for a printing stencil of a screen-printing machine in front view;

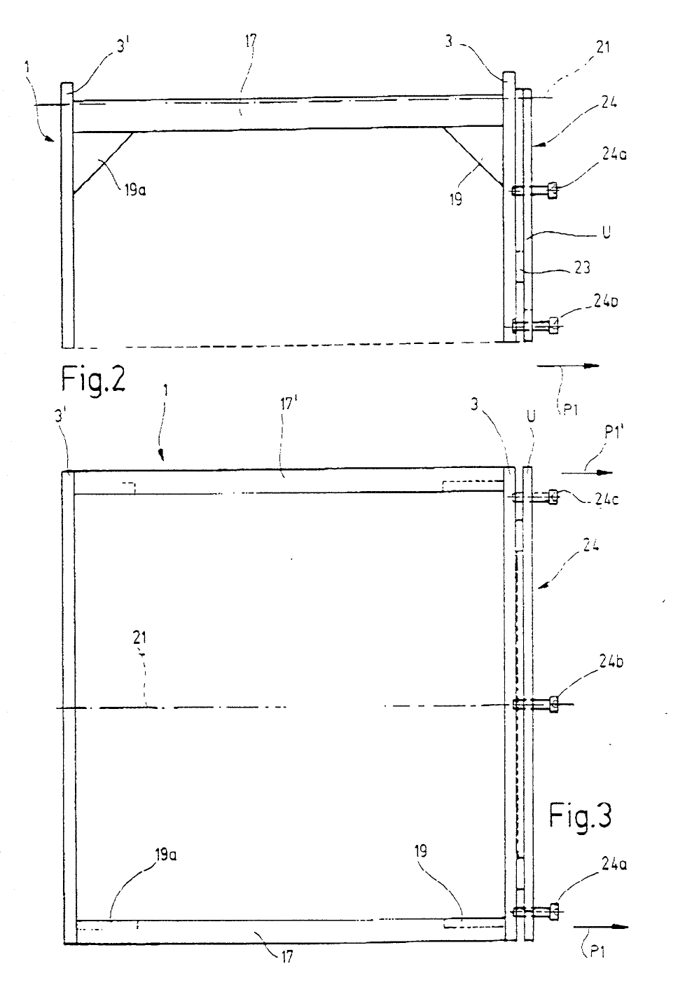

FIG. 2 shows the frame in side view;

FIG. 3 shows a plan view of the first exemplary embodiment of the frame, and

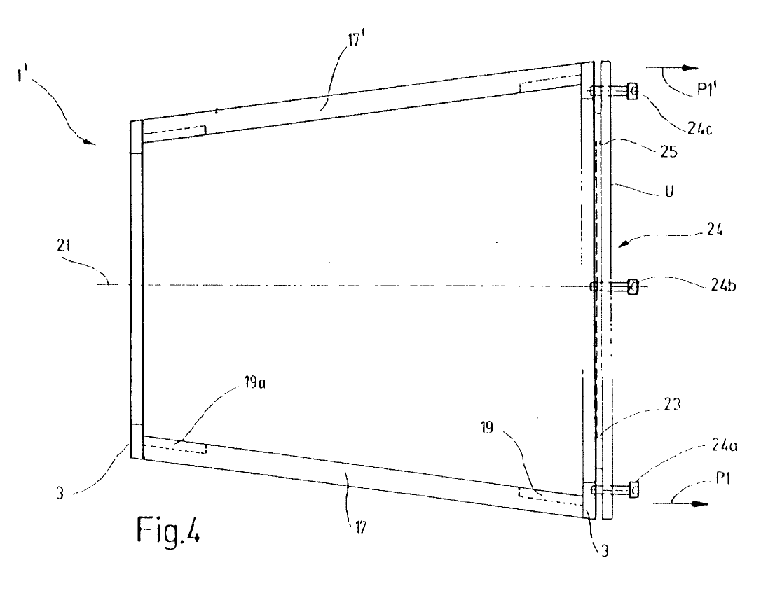

FIG. 4 shows a plan view of a second exemplary embodiment of a frame.

The first exemplary embodiment, illustrated in FIG. 1, of a frame 1 for a printing stencil of a screen-printing machine has, on two opposite ends, substantially U-shaped frame elements, of which here the first frame element 3 is illustrated, said frame elements holding a screen element. The definition that the frame element is U-shaped is extended to express the fact that the convex side of the first frame element 3, which is also referred to as the outer side, is of curved design. The contour of the first frame element 3 follows a circular arc here. The first frame element 3 is substantially semicircular. In the region of its mid-axis 7, it is drawn upward somewhat, so that the outer contour 9 provided here deviates from an imaginary diameter line 11.

In the region of the left-hand outer edge of the first frame element 3, a first longitudinal element 17 is provided, which extends rearward at right angles to the plane of the drawing in FIG. 1. Provided on the right-hand outer edge 15′, in mirror-image fashion to the mid-axis 7, is a corresponding second longitudinal element 17′, which likewise extends at right angles to the plane of the drawing of FIG. 1.

Arranged above the frame 1 is a first tensioning device 18, which is used to tension a screen fabric S fitted to the convex outer side of the frame 1 in the direction of the arrows P, P′. With the aid of said tensioning device, a tensioning force acting transversely with respect to the longitudinal extent of the frame 1 is introduced into the screen element and, respectively, into its screen fabric. To this end, the first tensioning device 18 is provided with tensioning elements E and E′ which run substantially parallel to the longitudinal elements 17 and 17′ and which extend at least over the entire length of the frame 1 running at right angles to the plane of the drawing of FIG. 1. For example, the tensioning elements E, E′ are designed as cylinders, on whose outer surface the screen fabric S is wound up. If the tensioning element E is designed to be driven in the clockwise direction and the tensioning element E′ is designed to be stationary or driven in the counterclockwise direction, then the screen fabric S is tensioned tautly in the direction of the arrows P and P′. This will be discussed in more detail further below. If appropriate, a plurality of such tensioning devices 18 can also be provided over the length of the frame 1.

FIG. 2 shows the frame 1 reproduced in FIG. 1 in side view. Clearly to be seen here—on the right—is the first frame element 3 which was explained using FIG. 1. Arranged opposite this—on the left—is a second frame element 3′, which is connected to the first frame element 3 by the longitudinal elements 17 and 17′. This illustration reveals the first longitudinal element 17.

From the side view, it is also possible to see that stabilization elements 19 and 19a can be provided, which ensure a secure connection between the longitudinal elements 17 and 17′ and the frame elements 3 and 3′.

Also shown in FIG. 2 is a pivot axis 21, which will be discussed in more detail.

On one of the frame elements, here on the first frame element 3′, it is possible to see an attachment 23, on which a drive can act.

FIG. 2 shows a second tensioning device 24 which here, by way of example, is arranged on the side of the first frame element 3. It has a U-shaped tensioning element whose outer contour, that is to say whose convex outer side, corresponds to the convex outer contour of the frame 1 and of the first frame element 3.

With the aid of tensioning means, the U-shaped tensioning element U can be displaced with respect to the first frame element 3. By way of example here, three screws arranged at a distance from one another are provided, of which here the first screw 24a and the second screw 24b are illustrated. The third screw 24c (see FIG. 3) is hidden behind the first screw 24a. The screws are led through holes which pass through the tensioning element U and are provided with an internal thread. They engage in depressions which are provided on that side of the first frame element 3 which faces the tensioning element U. If the screws 24a to 24c are screwed further in, then the tensioning element U is moved in the direction of the arrow P1.

The screen fabric S, indicated dashed here, is tensioned between the first frame element 3 and the second frame element 3′ in the finished printing stencil 1.

It is, of course, possible to arrange the second tensioning device 24 on the side of the second frame element 3′, or to allocate a tensioning device of the type described here to each frame element.

FIG. 3 shows the frame 1 in plan view. Identical parts are provided with the same reference numbers, so that to this extent reference is made to the description relating to the preceding FIGS.

The plan view clearly reveals that the longitudinal elements 17 and 17′ run parallel to each other, and that the frame elements 3 and 3′ are of identical width. The interior of the frame 1, as bounded by the frame elements 3 and 3′, therefore approximately circumscribes a half-cylinder.

Also clearly visible in the plan view is the tensioning element U. The illustration here shows all three screws 24a, 24b and 24c, with the aid of which the tensioning element U can be displaced in the direction of the arrows P1 and P1′, respectively.

A modified exemplary embodiment is revealed by FIG. 4. Identical parts are again provided with the same reference numbers, so that reference can be made to the preceding description.

The exemplary embodiment reproduced here is distinguished by the fact that the longitudinal elements 17 and 17′ form an acute angle, that is to say taper conically to the left. The internal space enclosed by the frame 1′ therefore approximately corresponds to half a section of a cone. As in the exemplary embodiment according to FIG. 3, the two frame elements 3 and 3′ run parallel to each other.

In the second exemplary embodiment of the frame 1′, illustrated in FIG. 4, a second tensioning device 24 is also assigned to the right-hand, first frame element 3, its construction being identical to that as was explained using FIGS. 2 and 3. To this extent, therefore, reference is made to the description above. Here, too, tensioning devices can be provided on both sides of the frame 1′, their construction corresponding to that of the second tensioning device 24 which was described above.

In the following text, the method for producing the frame 1 and 1′ will be discussed in more detail:

Firstly, a frame 1, 1′ is produced, as was explained using FIGS. 1 to 4. A molding is then introduced into the interior space enclosed by the frame elements 3 and 3′, the outer contour of said molding being matched to that of the frame elements 3 and 3′. A dashed line L in FIG. 2 indicates that the molding fills the free space between the frame elements 3, 3′, and that its outer contour corresponds exactly to the convex outer contour of this frame element. In particular, its convex outer surface follows the—substantially U-shaped curved—outer contour of the frame elements 3 and 3′. When the molding has been inserted into the frame 1, 1′, it forms a continuous convex surface together with the frame elements 3, 3′.

It is therefore possible to lay a screen fabric onto this convex outer surface of the frame 1, 1′. Said fabric therefore rests on the convex outer side of the frame elements 3 and 3′ and on the convex outer surface of the molding. The screen fabric S is then pretensioned in the direction of the arrows P, P′, transversely with respect to the longitudinal extent of the molding, with the aid of the first tensioning device explained using FIG. 1. The molding prevents the screen fabric being drawn into the hollow space enclosed by the frame 1, 1′ and by the frame elements 3, 3′ in the process and, so to speak, sagging between the frame elements 3 and 3′.

The screen fabric is then connected to the convex outer side of the second frame element 3′ and to the convex outer side of the second tensioning element U, or is fixed to this. Depending on the material of the screen fabric, a suitable fixing method is chosen here. It is therefore possible, for example, to bond the screen fabric firmly to the second frame element 3′ and the tensioning element U of the second tensioning device or, in the case of a metallic screen fabric, to weld the latter firmly to the second frame element 3′ and the tensioning element U, if an appropriate material is chosen here.

For the case in which the frame 1, 1′ is to be used in order to process thermoplastic inks which have to be heated for the purpose of processing, electrically nonconductive insulating material is fitted between screen fabric and frame 1. It is then possible to use an electrically conductive screen fabric and to heat the latter up with the aid of electrical current. Of course, it is also possible to produce the frame itself from electrically nonconductive material. The screen fabric can then be fitted directly to the frame without inserting additional insulating material.

After the fixing of the screen fabric to the second frame element 3′ and to the tensioning element U has reached a sufficient strength, that is to say for example following the curing of an adhesive, the frame element 3 is displaced in the direction of the arrows P1, P1′ by means of the screws 24a, 24b, 24c. In the process, the clear spacing between the second frame element 3′ and the tensioning element U is increased, so that the screen fabric is also subjected to tension in the longitudinal direction of the frame 1, 1′ and, respectively, in the direction of the pivot axis 21.

Following the setting of the desired spacing between the second frame element 3′ and the tensioning element U, that is to say after a desired tensioning force has been introduced into the screen fabric, the latter is fixed to the first frame element 3 and also to the longitudinal elements 17, 17′, adhesive bonding or welding being possible here, too, depending on the material combination. The tensioning element U can then be removed.

After the screen fabric has been fastened to the frame 1, 1′, projecting fabric parts can be cut off. The screen fabric then forms a finished screen element of a printing screen.

The molding introduced into the interior of the frame 1, 1′ can now be removed at the latest. It is also possible to take it out from the frame as early as when the fixing of the screen fabric to the U-shaped frame elements 3, 3′ has been carried out.

With the aid of the method described here, a printing stencil in a screen-printing machine is fixed to the frame 1, 1′ with a pretension extending both in the longitudinal direction and also transversely thereto. It can then be used in a screen-printing machine.

During the printing of an article, a pressure squeegee is introduced into the interior of the frame 1, 1′ and, in a known manner, applies ink to the surface of the article. In the case of a frame 1 according to FIG. 3, said article can have a cylindrical surface and, in the case of a frame 1′ according to FIG. 4, can have a conical surface or, respectively, a conical surface area.

When printing is being carried out, the article to be printed is rotated, while the frame 1, 1′ carries out a pivoting movement about the pivot axis 21. In the process, the pressure squeegee follows the line of contact between the screen fabric fitted to the frame 1, 1′ and the surface of the article to be printed.

It can readily be seen that, given a pivoting movement of the frame 1, 1′ about its pivot axis 21, the space it requires is extremely small. Screen-printing machines having a printing stencil of the type described here are therefore very small. If such a printing stencil is used with a known rotary index table, it transpires that substantially more printing stations can be accommodated on a rotary index table than is the case with flat printing stencils. This is because during the printing of round or cylindrical articles, said flat printing stencils are subjected to a movement lying in one plane, which requires a great deal more space than when the printing stencil described here, with the frame 1, 1′, is used.

It becomes clear that, in order to carry out the screen-printing process, the frame 1, 1′ is coupled to a suitable drive which, for example, acts on the attachment 23 and effects the pivoting movement of the frame 1, 1′ about the pivot axis 21. The attachment 23 can optionally be provided on the first or second frame element 3, 3′. If required, it is also conceivable to have a drive engaging on both sides of the frame 1, 1′.

It can readily be seen that the frame 1, 1′ described here is particularly advantageous, since the printing stencil and, respectively, the associated frame parts are substantially U-shaped, that is to say surround a space which is open on one side. When screen printing is being carried out, the pressure squeegee can act in this space without difficulty. It is readily possible to combine the frame 1, 1′ described here with conventional pressure squeegees, and also to retrofit existing screen-printing machines with such a frame.

1. A printing stencil for a screen-printing machine, having a frame holding a screen element, wherein the screen element is substantially curved in a U shape, and wherein its concave side is assigned to a pressure squeegee and its convex side is assigned to the surface to be printed.

2. The printing stencil as claimed in claim 1, wherein the frame (1; 1′) has at least two substantially U-shaped frame elements (3; 3′) which are arranged at a distance from each other and whose spacing is variable.

3. The printing stencil as claimed in claim 1 or 2, wherein the screen element is cylindrically curved.

4. The printing stencil as claimed in claim 1 or 2, wherein the screen element is conical.

5. The printing stencil as claimed in one of the preceding claims, which comprises at least one first tensioning device (18) by means of which a tensioning force acting transversely with respect to the longitudinal extent of the frame (1; 1′) can be introduced into the screen element.

6. The printing stencil as claimed in one of the preceding claims, which comprises at least one second tensioning device (24) by means of which a tensioning force acting in the direction of the longitudinal extent of the frame (1; 1′) can be introduced into the screen element.

7. The printing stencil as claimed in one of the preceding claims, wherein a drive device is provided which subjects the printing stencil to a pivoting movement in such a way that the pivot axis (21) runs substantially parallel to the longitudinal extent of the printing stencil.

8. The printing stencil as claimed in one of the preceding claims, wherein insulating material is provided between the screen element and frame elements (3, 3′), or the frame elements (3, 3′) are produced from electrically nonconductive material.

9. A method for producing a printing stencil, having the following steps:
introducing a molding with a substantially U-shaped curved outer surface into a frame (1, 1′) having substantially U-shaped frame elements (3, 3′) arranged at a distance from each other;
fitting a screen fabric to the convex side of the molding and the frame elements (3, 3′);
tensioning the screen fabric transversely and longitudinally with respect to the longitudinal extent of the molding and of the frame elements (3, 3′);
fixing the screen fabric to the convex side of the frame elements (3, 25); displacing the frame elements (3, 25) in such a way that their spacing is increased, in order to tension the screen fabric in the longitudinal extent of the molding, and
fixing the screen fabric to the longitudinal elements (17, 17′) of the frame (1, 1′).
